(19) United States
(12) Patent Application Publication
(10) Pub. No.: US 2007/0208840 A1
(43) Pub. Date: Sep. 6, 2007

(54) GRAPHICAL USER INTERFACE FOR NETWORK MANAGEMENT

(75) Inventors: Anton MCCONVILLE, Ottawa, ON (CA); Peter CHAN, White Lake, ON (CA); Mark HINDS, Ottawa, ON (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(73) Assignee: NORTEL NETWORKS LIMITED, St. Laurent, QC (CA)

(21) Appl. No.: 11/427,613

(22) Filed: Jun. 29, 2006

Related U.S. Application Data
(60) Provisional application No. 60/778,381, filed on Mar. 3, 2006.

(51) Int. Cl. G06F 9/00

(52) U.S. Cl. 709/223; 715/736; 715/733; 715/764

(57) ABSTRACT

A graphical user interface (GUI) provides a plurality of views of a network and its elements in the same viewing engine. A user can switch between the plurality of views in a context-sensitive manner, each view showing relationship or interconnection information. The GUI allows a user to view inter-related objects at the same level, and to view at a lower level sub-objects that make up each of those objects. Different functional views can be provided at the same hierarchical or logical level based on the stored relationship information. A user can navigate between a network level view, a site level view, a shelf level view, and a schematic level view, via element selection or by zooming. A network element data set provides context-sensitive data and images to each level and view for that network element and enables automatic generation of a network topology.

### CROSS REFERENCE TO RELATED APPLICATIONS

This application claims the benefit of priority of U.S. Provisional Patent Application No. 60/778,381 filed Mar. 3, 2006, which is incorporated herein by reference.

### FIELD OF THE INVENTION

The present invention relates generally to network management user interfaces. More particularly, the present invention relates to graphical user interfaces (GUIs) for management of telecommunications networks.

### BACKGROUND OF THE INVENTION

Network management is an important feature of complex telecommunications networks. In a complex network, there are many different aspects (e.g., layers, connections, channels, nodes, cards and ports) which can be managed. Many of these aspects have thus far been managed by disassociated applications. Representing all of these aspects to someone managing the network has been extremely challenging with existing graphical user interfaces.

The concept of branching in optical networks introduces a new level of interconnectedness at the network level. Branching provides the ability to optically route between network elements co-located on a site, and effectively between different management and control regions within a large network with multiple independently managed and controlled groupings of network elements. Since functional interaction often requires interaction with more than one shelf, a display of more than one shelf is therefore desired.

Graphical user interfaces for web based map applications allow a user to zoom to change the level of detail being displayed, or pan to change the area of the map being viewed. However, such a system has not previously been deployed in a network management system, despite the known complexity of network management.

### SUMMARY OF THE INVENTION

In an aspect, the present invention provides a GUI for managing network elements in a network. The GUI includes a first level view to display a plurality of network element groupings in a network context, showing relationships between the network element groupings. The GUI includes a second level view to display a selected network element grouping from the first level view, the second level view showing lower level properties in the network context of at least one network element of the selected network element grouping. Such a GUI permits a person managing a network to conveniently navigate the management aspects of the network from a single application.

In an embodiment, the first level view is a site level view and the network element groupings are site groupings comprising network elements co-located at the same physical site. In another embodiment, the first level view is an optical system topology view and the network element groupings are optical system identification (OSID) groupings comprising network elements having the same OSID. In the optical system topology view, the OSID groupings can themselves include site groupings comprising network elements co-located at the same physical site.

The GUI can further include an alternate functional view displaying functional properties associated with the displayed related network elements. A currently displayed view can show a portion of a total viewable image as seen through a viewport. The viewport can pan across the total viewable image in response to user direction, displaying relationship information while panning. The viewport can trigger an action event in response to panning across a panning boundary. The GUI can include a single network element data model for each network element to provide a view-specific network element vector graphic with context-sensitive detail for each of the views. A level navigator can switch between the first level view and the second level view in response to user activation, which can include: selection of the selected network element in the first level view; or zooming in on an area that includes the selected network element in the first level view. The zooming can trigger the level navigator in response to crossing a zoom boundary of two functional areas.

The GUI can further include a third level view lower in hierarchy than the second level view and showing properties in the network context of a card of the at least one network element. In that case, a level navigator can switch directly between the first level view and the third level view in response to user activation without displaying the second level view. The third level view can include a graphical port level alarm indication to display an alarm in a network context. The GUI can further include a network topology engine to automatically discover and generate a network topology without user input. An image export function can export a displayed image from the GUI at any level or view. The network can be a telecommunication network or an optical network.

In another aspect, the present invention provides a computer readable medium containing computer instructions which, when executed, cause a processor to provide a graphical user interface (GUI) for enabling management of network elements in a network. The computer readable medium comprises: instructions for displaying, in a first level view, a plurality of network element groupings in a network context, showing relationships between the network element groupings; and instructions for displaying, in a second level view, a selected network element grouping from the first level view, the second level view showing lower level properties in the network context of at least one network element of the selected network element grouping.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a first level view of a graphical user interface according to an embodiment of the present invention;

FIG. 2 illustrates a first level view of a graphical user interface according to another embodiment of the present invention;

FIG. 3 illustrates a second level view of a graphical user interface according to an embodiment of the present invention;

FIG. 4 illustrates a second level view of a graphical user interface according to another embodiment of the present invention;

FIG. 5 illustrates panning using a zoomable graphical user interface according to an embodiment of the present invention;

FIGS. 6A and 6B illustrate scaling using a zoomable graphical user interface according to an embodiment of the present invention;

FIGS. 7A and 7B illustrate context switching using a zoomable graphical user interface according to an embodiment of the present invention;

FIG. 8 illustrates context switching by zoom centering using a zoomable graphical user interface according to an embodiment of the present invention;

FIG. 9 illustrates navigation from a site view to a schematic view using a zoomable graphical user interface according to an embodiment of the present invention;

FIG. 10 illustrates a port level alarm indication of a graphical user interface according to an embodiment of the present invention;

FIG. 11 illustrates viewing port level traffic from a shelf view of a zoomable graphical user interface according to an embodiment of the present invention; and

FIGS. 12A, 12B, 12C and 12D illustrate additional features of a zoomable graphical user interface according to an embodiment of the present invention.

### DETAILED DESCRIPTION

Generally, the present invention provides a GUI that provides a plurality of views of a network and its elements in the same viewing engine. A user can switch between the plurality of views in a context-sensitive manner, each view showing relationship or interconnection information. The GUI allows a user to view inter-related objects at the same level, and to view at a lower level sub-objects that make up each of those objects. Different functional views can be provided at the same hierarchical or logical level based on the stored relationship information. A user can navigate between a network level view, a site level view, a shelf level view, and a schematic/card level view, via element selection or by zooming. A network element data set provides context-sensitive data and images to each level and view for that network element and enables automatic generation of a network topology.

While network management systems operate at higher layer of software in the management hierarchy, in an embodiment the present invention operates at the individual Network Element (NE) level and relies on the “network awareness” features of common photonic layer (CPL) software. Most known approaches do not provide this capability at such a low level in the network management hierarchy. Nonetheless, the functionality of embodiments of the present invention is re-usable at every layer above the level at which a single NE is logged in to.

An embodiment of the present invention provides a GUI for a network element management system. The GUI can reduce the number of operations required to obtain information and can be described as enabling recursive layer/level navigation. While embodiments of the invention will be described using an example relating to managing an optical network from a web based user interface, this is simply an illustrative example. Embodiments of the present invention are equally applicable to other types of telecommunication networks, such as data networks and cellular telephone networks, offering the ability to scale across networks regardless of the type of network. For example, with the prevalence of voice-over-IP phones, a system according to an embodiment of the present invention can be used to identify a phone on which software has been corrupted and requires attention. This same toolbox can also be used for SONET (Synchronous Optical Network) ring display, SONET protection path display, optical amplifier relationships, etc. The layers that can be navigated can include SONET layers, data layers, etc. Effectively, it is possible to visualize the world (from a network perspective) in different layers.

The GUI, which can be implemented as a thin client via a web-based distribution, enables switching between a plurality of different yet related views, each showing relationship information. In an embodiment, these views include: a network level view, a site level view, a shelf level view, and a schematic/card level view. These views can be related to each other by commonly displayed elements, even if they display differently, and by showing similar elements at different zoom levels. For example, a shelf level view at a specific zoom level will illustrate all of the “cards” optically interconnected; this view is also referred to as a “schematic” level view. The card level view is a higher zoom level of the schematic, but focused/centered on a single card, so that the details of the card (such as internal schematic with port numbers and labels) are fully visible. It is optional as to whether the card level view is functionally tied together with the physical display of the shelf.

Each of these views includes information regarding relationships between displayed elements. A relationship can be a physical connection or a logical connection or grouping. Generally, the system permits a person managing a network to conveniently navigate the management aspects of the network from a single application and from a single entry point. A particular embodiment allows the user to zoom from a network topology view right down to node or even a card schematic view (and potentially further). It allows a user to visually navigate multiple layers or multiple functional and/or physical areas of the network.

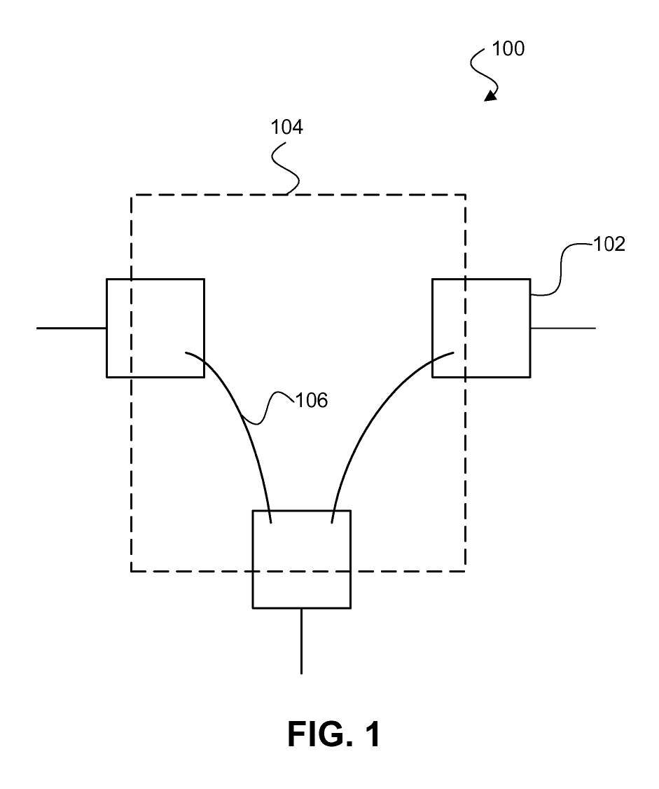

As mentioned earlier, branching in optical networks often requires interaction with more than one shelf, and a display of more than one shelf is consequently desired, particularly as network complexity increases. For example, on a branched network there can be two or three different groups of network elements to log into to trace a path for a particular wavelength. Therefore, an embodiment of the present invention demonstrates such interconnectedness as shown in FIG. 1, which is a first level view of a GUI according to an embodiment of the present invention. In this case, the first level view is a site level view 100 showing three nodes. Though three-way interconnectedness is shown, the GUI is presently scalable up to 9-way interconnectedness, and can be scalable to show any degree of inter-relationship. The site level view 100 can show all network elements (NEs) 102 at the same network element grouping 104, which in this case is a physical site. The GUI can optionally show optical routing 106 between NEs at the same site. The GUI also provides the ability to deal with branching provisioning, and to discover or trace a wavelength crossing between nodes at a branch site.

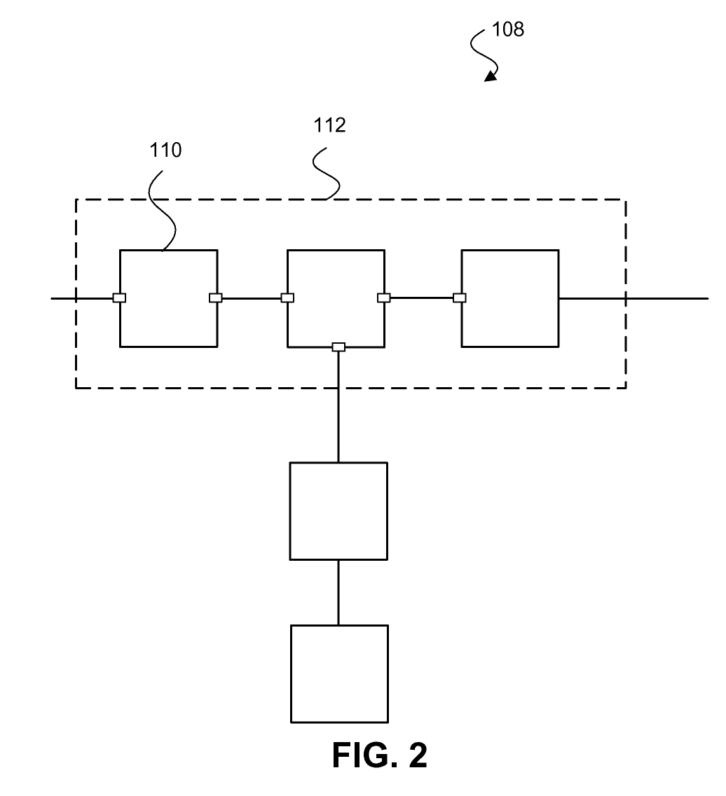

Another embodiment of the present invention additionally provides the ability to display an “optical system topology” (OST) as a first level view. This exposes to the outside world the internal data model for shelves that are inter-related, including not just equipment that is co-located, but rather equipment from a collective of shelves in the same managed group. FIG. 2 illustrates an optical system topology 108 in which a plurality of sites, 110 each having a different site ID can exist as a network element grouping 112, having the same optical system ID. Because of branching, a network element can branch off to another NE having a different optical system ID (OSID). This optical system topology view is substantially equivalent in hierarchy to a network-site level view with visibility of individual NEs, but it groups together and highlights NEs based on OSID membership rather than just physical sites. In other words, a logical optical site, or OSID grouping, 112 is similar in nature to a physical site 102 in FIG. 1 in that they each represent a network element grouping, and each grouping includes one or more NEs. One difference is that the OSID grouping 112 can include a plurality of physical sites 110, each of which in turn can include one or more NEs.

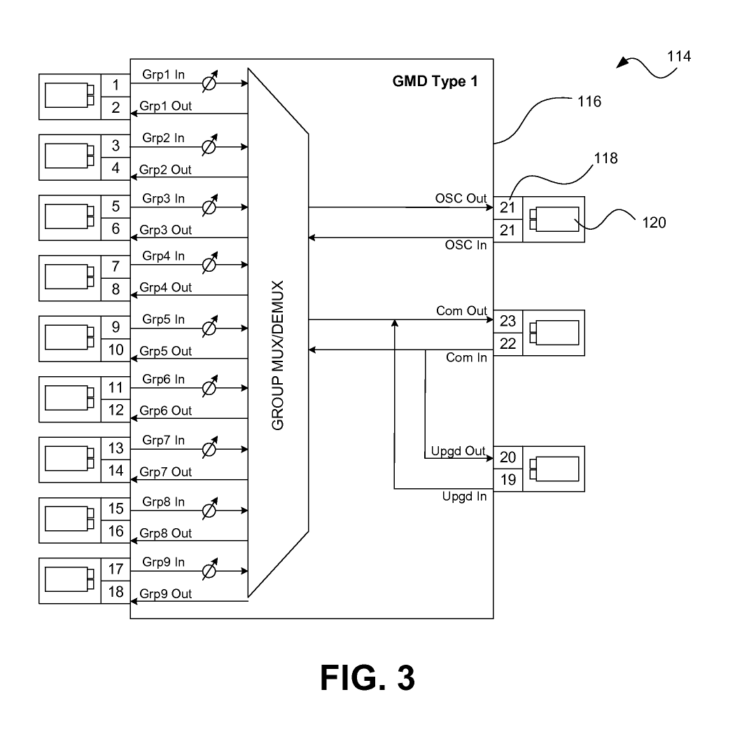

Further available views include a per-card navigatable schematic view, and a shelf level view, which is higher in hierarchy than the schematic level view, in that it is at a different zoom level. The schematic view shows a detailed picture of the card in context in the graphics view, and a detailed schematic of the selected card. In a presently preferred embodiment, the details of only one card or adjacent card are displayed at any given time. FIG. 3 illustrates a second level view 114 according to an embodiment of the present invention that shows a shelf, and a selected card 116 on the shelf. In the case of FIG. 3, there is one card on the shelf, though a plurality of cards can be located on a single shelf and displayed in this view. Additional data indicating the shelf number and slot number are advantageously provided. The selected card 116 is shown in its relationship context, which in this case is a physical connection context. The GUI shows a plurality of connection points, or ports, 118 to which the selected card is connected (either physically or logically) in order to enable communication with other cards 1120. By selecting one of the other cards 120, such as by selecting the connection point 118 to which it is connected, that other card will become the selected card and will appear magnified and in detail in the main portion of the GUI. This provides the ability to jump from node to node within the same level view. In the magnified view, details are preferably displayed relating to an internal schematic including port numbers and names, facility symbols and internal optical connections.

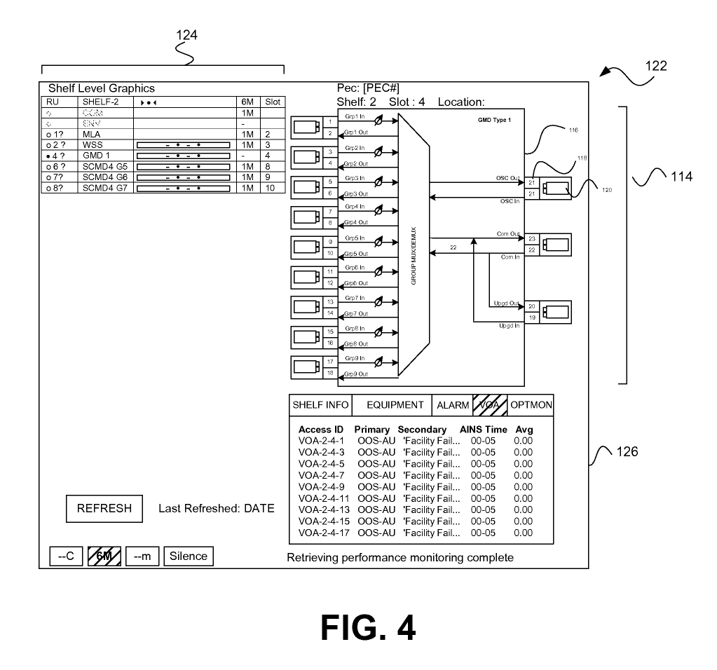

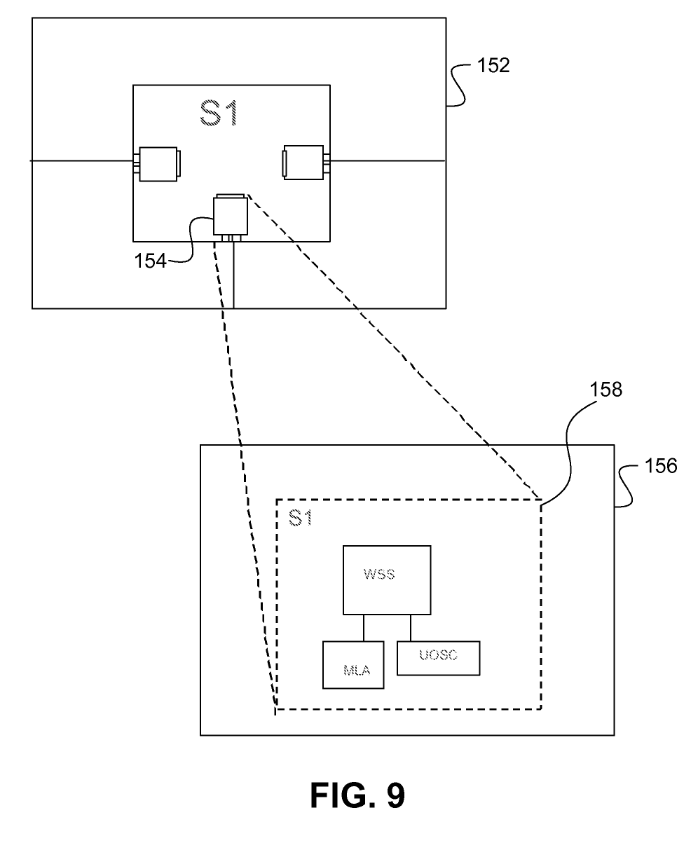

FIG. 4 illustrates a second level view of a graphical user interface according to another embodiment of the present invention. In this embodiment, the second level view 114 is provided in a main viewer area in which the logical graphics described above are displayed. Data is preferably displayed relating to the selected card in an adjacent data window. A first auxiliary viewer 124, such as a side panel, can present functional area specific control functions, or widgets, that are relevant to the graphics being displayed in the main viewer. A second auxiliary viewer 126, such as a data viewer, can provide data relating to the graphics being displayed in the main viewer, similarly reflecting the current context (e.g. alarms, provisioning data, measured sensor data). The selected card is shown in the context of its connection points. The detail shown in the schematic view is useful because it means from a usability point of view that when a user selects a port, the filtering includes the internal equipment (facilities) that is tied to that port. Different facility types can be represented by different figures or shapes in the schematic level view, which makes it a visual representation of a facility model. For instance, if there is a loss of signal at a selected port, the GUI shows that the loss of signal would be at the tap monitor represented, and also shows a facility as being a VOA facility represented by a particular shape. It is also possible to logically understand the flow of a wavelength, since you can see which ports have one or more wavelengths on it. An example of a schematic view will be described later in relation to FIG. 9.

A menu-driven system or a set of predefined zoom level buttons can be provided to select and switch between: schematic level view; shelf level view; site level view; and network level view. A viewer in the GUI permits a user to view multiple connected schematics, or to view a layer hierarchy, as well as to move in a page-by-page view along the larger schematic view (which generally can not be viewed in its entirety within the viewer), with page-to-page interconnects. By hovering over a box, the GUI provides an indication of the various connections, such as the port on a given device, or the address of another NE. It is also possible to trace a particular channel from a given card along its path. In a port-level view, alarms are shown visually on the actual port on which they are occurring.

In many views only a small portion of a total viewable image, also referred to as a “canvas”, can be displayed in a viewport, or viewable portion, of the GUI. Therefore, in an embodiment, a zoomable graphical user interface is provided to simplify switching between the site view, the shelf view, and the schematic view, in a way that provides relationship information, such as a network topology context, to the displayed information. This provides a substantially seamless means for looking at the system in its fullness and in real-time. Known systems generally do not provide the network topology context, in which case a user can only guess at which shelf needs to be looked at based on a sense from the other views. Zooming can be used for real estate optimization or context navigation, or both. The term “zoomable” is used herein to represent a GUI in which a user can change the magnification of a view, and the change can either scale existing graphics or change the graphics in response to crossing a zoom boundary to reveal a different view. A zoomable interface can enable types of views that are intermediate to other hierarchical or logical views, providing enhanced flexibility and functionality in the display of relationship information, such as network context, of network elements and network element groupings.

As the user zooms from the bird's eye view downwards, they can click on a graphical representation of the network to query and provision manageable components of the system. Provisioning can be made available at some zoom levels and not others. Telecommunication configuration data traditionally managed by disassociated applications can now be related using a single application which provides a single point of cross functional area data access. The GUI allows the user to fluidly browse from complete network topology to modular components, for example, on a single NE, shelf or card. It offers the user a much more visually complete understanding of the network they are managing, and a very natural means of navigating around it. While these navigational features are available in embodiments that do not include the zooming feature, the zooming feature can further facilitate navigation and provide additional capabilities.

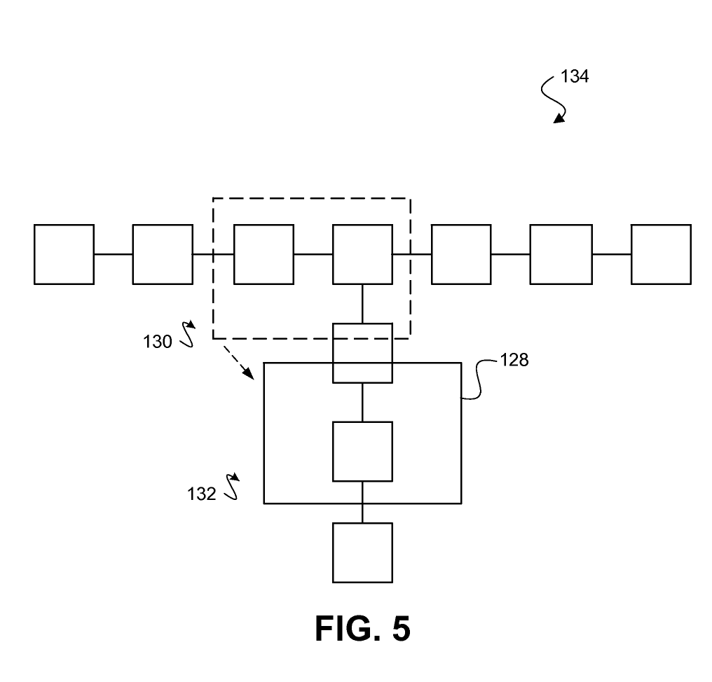

FIG. 5 illustrates panning using a zoomable graphical user interface according to an embodiment of the present invention. Instead of having to switch between different views simply to see other portions of the network, embodiments of the present invention provide the ability to pan a viewport 128 from one area 130 of the network topology to another area 132, providing a larger-than-viewport real estate for the graphics. By selecting an area, for example using a keyboard or mouse, a user can pan the viewport on a total viewable image 134 to view a graphics in a portion of the canvas in any direction. While similar Web 2.0 technology exists in the field of geographical map viewing, this panning feature is now being provided in the context of network navigation, which has many different features, including the fact that the “background” image representing the network changes over time, such as in response to changes in network topology, status, provisioning, etc. (The term Web 2.0 refers to a second generation of online services that gives users an experience closer to desktop applications than traditional static Web pages, encouraging users to collaborate, communicate and share information online.)

The action of panning the viewport 128 can also trigger an action event. For example, when the user pans the viewport 128 from one shelf to another shelf, the current viewport is now focused on a different shelf which might have additional functional significance. So, apart from the existing graphics being shifted, one or more action events can be triggered to cause multiple external actions, for example additional data retrieval and switching widgets on the management tool. The viewport can trigger an action event in response to panning across a panning boundary. A panning boundary can be defined at an edge of each shelf, card, network element, site, etc.

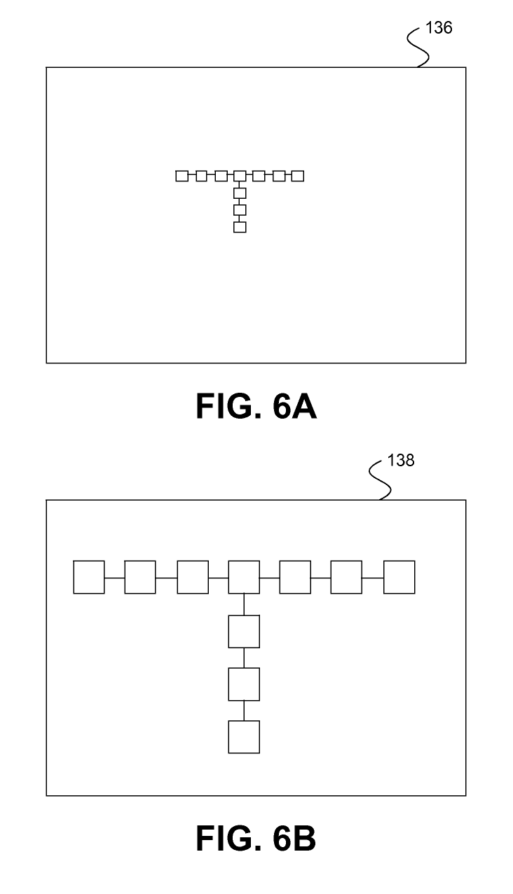

Embodiments of the present invention can also show more detail as a user zooms in. FIGS. 6A and 6B illustrate scaling using a zoomable graphical user interface according to an embodiment of the present invention. The entire view (or network view) can fit within a single screen; it is then possible to zoom in to the detail of each circuit pack, and ultimately to each port. While graphics can change depending on the zoom, there is also provided the ability to simply scale the image without changing the graphics. Images 136 and 138 in FIGS. 6A and 6B are scaled versions of each other.

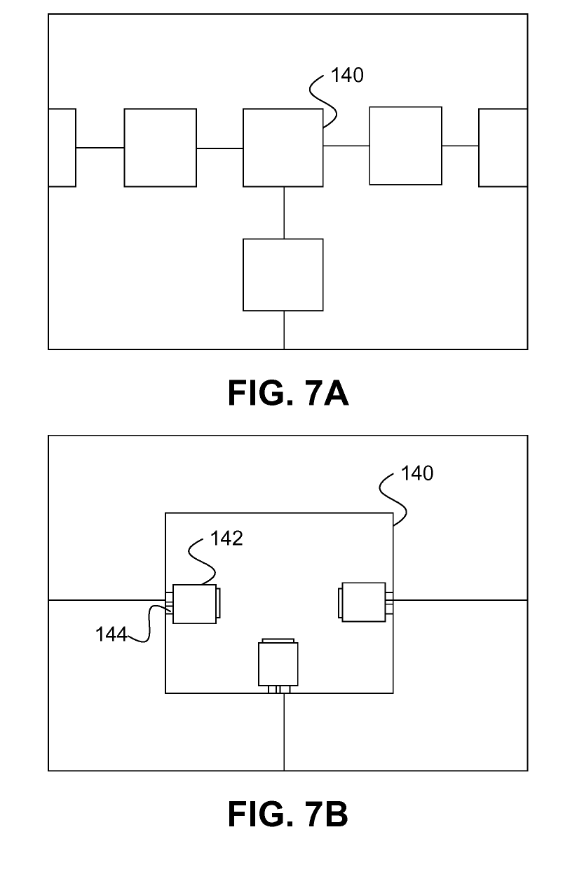

The zoomable interface according to an embodiment of the present invention can be reactive to parts of the system that the user is looking at. FIGS. 7A and 7B illustrate a context switch using a zoomable graphical user interface according to an embodiment of the present invention. For example, FIG. 7A illustrates a portion of a site view including a site 140. As a user zooms into the site view, telecommunications shelves can be shown. FIG. 7B shows the site 140 with different graphics representing a plurality of network elements 142 with shelves/cards. As the user zooms to the shelves, the ‘tops’ can be opened on the shelves to reveal logical circuit pack schematics beneath. Cards can be viewed by standard schematics and/or a facility model. Schematics include traffic ports 144 that can be clicked on to reveal table based information, and alarm information relating to those ports. In FIGS. 7A and 7B, the context switch is triggered by zooming. The zooming action can trigger a context switch when a zoom boundary of two functional areas is crossed. Graphics relevant to the level entered will replace the graphics of the level exited. The content of side panels can also change when the zoom boundary is crossed.

According to an embodiment of the invention, graphical telecom components can be rotated in 3D revealing more information ‘behind’ them or at a different dimensioned ‘side’ of the component. Images can be overlayed on top of the network images to show the different aspects of the network, for example, connections or wavelength trails. Data and connections can be dragged and dropped between components of the zoomable user interface (ZUI). Network elements can be selected and upgraded using the zoomable interface. Snapshots of the interface can be saved, for example as an xml file, or image file at different points in the zoom. In one embodiment, a smaller scaled encapsulation of the network can be viewed in a smaller window. A screen capture and print function allows a user to print any view at any level and export to a different format. This can be advantageous if it is necessary to obtain assistance from a network operation center or any other third party. This exported data includes much more information than is available using known approaches.

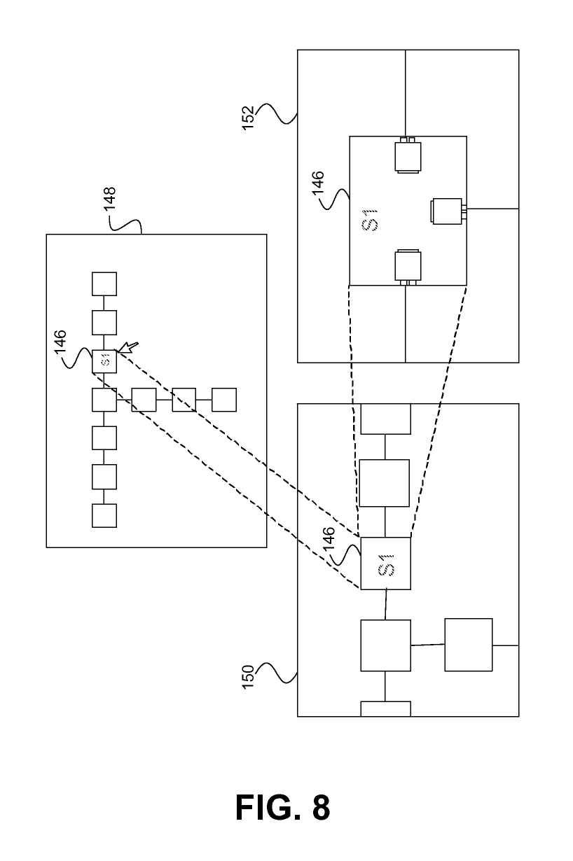

FIG. 8 illustrates a context switch by zoom centering using a zoomable graphical user interface according to an embodiment of the present invention. This embodiment preferably uses scalable vector graphics, which are mathematically based and much more economical in terms of memory consumption, as opposed to providing a plurality of separate static GIF images or other image files to represent the same network element at different levels, or in different functional views. Vector graphics also make it easier to proportionalize and dimensionalize images. Since vector scaling has a zoom focal point, the GUI provides a way to adjust the focal coordinate, also called the zoom focus. This zoom focus can also be used as the selection control for the zoom triggered context switch. For example, if a user selects object S1 (146) as shown in FIG. 8 as the zoom focus while in an entire network view 148, the selected object 146 stays in relative view during vector scaling, and is the focus of a context switch, or a plurality of context switches. FIG. 8 shows a context switch between the entire network view 148 and a scaled and zoomed view 150, or site view, showing a portion of the network view and a plurality of sites, including site 146. A further context switch is shown from the view 150 to a view 152 providing details regarding site 146 and the network elements at that site.

A further context switch is shown in FIG. 9, which illustrates navigation from a site view to a schematic view using a zoomable graphical user interface according to an embodiment of the present invention. FIG. 9 shows “drilling down” from the site level view 152 by selecting a particular shelf 154 at the site about which further information is desired. As a result of this context switch from shelf view 152 to schematic view 156, the GUI reveals a detailed card schematic 158 of the selected shelf 154, while advantageously displaying an indicate of the site (or network element grouping) to which the selected shelf belongs. The site indication, or network element grouping indication, can be a physical site ID or an optical site ID.

The zoomable interface can display a graphical rendition of the network features as discovered by the network management system. Network features or components are revealed as they are added (and tracked by the network management system). At the highest level, all of the network elements have the same data, and appear substantially the same in that view. As a user zooms in, he/she “logs in” to a different level. While it is somewhat similar in nature to a navigation tree, it is different in that interconnected topology information is shown. This provides the ability to select a box, log into that box and see the network elements connected to that box. As the GUI zooms in, all of the information relating to that network element is already in context with respect to topology. The GUI also provides the ability to change the view of the functions at each layer. Some operations make sense for certain layers, and some data is not relevant at a lower level.

Additionally, new demands can be provisioned at a network layer, and new light paths can be followed and data can be overlaid. Alternatively, the system can show a list of all of the demands, and for each demand it would show the path that it would take. Another element is the communications infrastructure. Even the physical layer can be viewed, such as a mini-stack for each shelf.

Trouble resolution, such as alarm resolution, is an advantageous application of a network management system. In known systems, it is possible to navigate through various layers (network, site, shelf) to discover information relating to an alarm. However, this navigation is done via unrelated applications that each take care of displaying a particular layer, and do not interact with one another. Also, an often used number-based alarm indication (in shelf-slot-port format) is of limited practical use to many users. Therefore, an embodiment of the present invention shows a physical view with the cards lined up in the way they are physically built into the shelf. That way, someone standing in front of the shelf can see it in the same way as in the graphical interface. Also, by providing many related views within a single application, an embodiment of the present invention obviates the need to log in to each element and level in succession to identify an alarm, which can greatly assist an unskilled user.

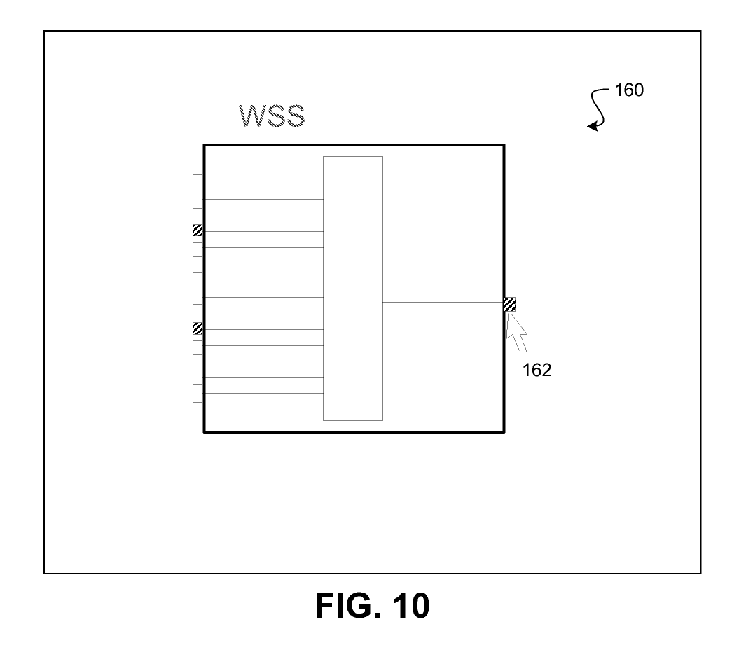

FIG. 10 illustrates a graphical port level alarm indication functionality, or module, using a zoomable graphical user interface according to an embodiment of the present invention. The graphical port level alarm indication 160 is used to display an alarm in a network context. A data window (not shown) alongside the graphical window can show data relating to the selected element (facilities, alarms, equipment data, etc.), in a context-sensitive manner, without requiring the user to enter menus. This means that a user does not have to understand the shelf-slot-port alarm format, and can instead make use of the graphical user interface to accomplish tasks more efficiently, which can facilitate and speed up alarm resolution. After selecting an alarmed port 162, shown in FIG. 10, alarm and facility data is filtered at the port level and can be easily displayed.

By showing the alarm in a topology context, an embodiment of the present invention can assist in identifying an underlying cause of the alarm, because alarms often occur in groups and not in isolation. Identifying a primary alarm, i.e. an alarm causing other alarms and for which a service call must be placed, is difficult if not impossible with existing systems, since there is no automatic way to identify inter-relatedness and inter-connection in topology. One advantage of a topology context-sensitive view is that, for example, if an alarm appears somewhere and you see it is a receiver loss of signal, you want to be able to trace the topology to its origin. Embodiments of the present invention provide this ability, based on the presence of topology information in the network, such as at each network element.

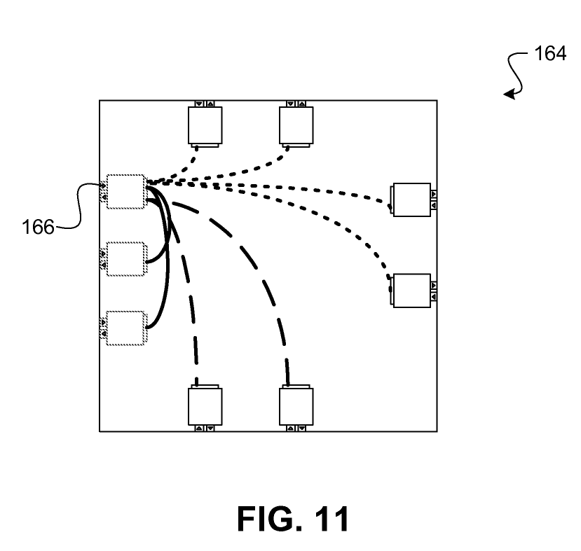

FIG. 11 illustrates viewing port-level traffic from a shelf view 164 of a zoomable graphical user interface according to an embodiment of the present invention. This view can be described as an optical bandwidth manager, or optical bandwidth management module. Selecting an ingress port 166 of a shelf can illuminate the traffic flow from that shelf, as shown in FIG. 11. Different types of traffic can be represented visually by different graphics. Activating a zoom out button can cause the interface to zoom out from the site, while activating a zoom in button can zoom in to a shelf revealing schematics of equipment within it. The schematics are preferably “live”, meaning that clicking on components and ports of the schematics will display the relative provisioning information for them. A mouse wheel movement or any defined keyboard sequence can accelerate zooming, such as providing the ability to zoom out directly from a schematic view to a network topology view without viewing the intermediate views or contexts.

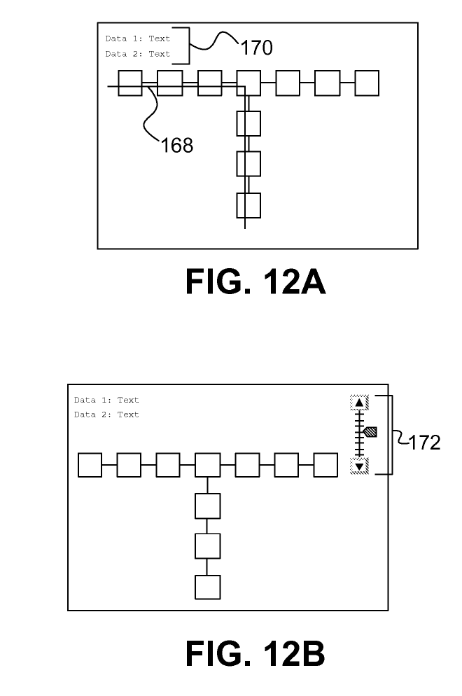

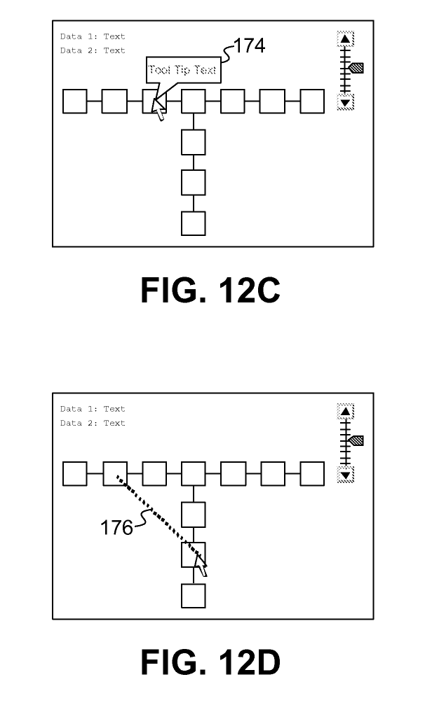

FIG. 12 illustrates additional features of a zoomable graphical user interface according to an embodiment of the present invention, such as different layers or tools that can be overlayed on the basic underlying graphic canvas layer. FIG. 12A shows an overlay data layer, which can include a graphic 168 representing a path trace, as well as header text 170. FIG. 12B shows a widget layer, which can be used to show a function such as a zoom slider 172. FIG. 12C shows a popup and tool tip layer, which can show text 174 relating to a selected item within the view, typically in response to hovering over the item or selecting it I some other manner. FIG. 12D shows a drag and drop layer, in which two items in the view can be associated, or their relationship can be defined by selecting a first item and dragging a cursor to the second item as shown by the trail 176.

It is much easier and quicker to get network information using an embodiment of the present invention than with previous systems, especially in view of the fact that the number of NEs on a given network is constantly increasing.

To recap, in an aspect, the present invention provides a GUI for managing network elements in a network. The GUI includes a first level view to display a plurality of network element groupings in a network context, showing relationships between the network element groupings. The GUI includes a second level view to display a selected network element grouping from the first level view, the second level view showing lower level properties in the network context of at least one network element of the selected network element grouping. Such a GUI permits a person managing a network to conveniently navigate the management aspects of the network from a single application.

In an embodiment, the first level view is a site level view and the network element groupings are site groupings comprising network elements co-located at the same physical site. In another embodiment, the first level view is an optical system topology view and the network element groupings are optical system identification (OSID) groupings comprising network elements having the same OSID. In the optical system topology view, the OSID groupings themselves include site groupings comprising network elements co-located at the same physical site.

The GUI can further include an alternate functional view displaying functional properties associated with the displayed related network elements. A currently displayed view can show a portion of a total viewable image as seen through a viewport. The viewport can pan across the total viewable image in response to user direction, displaying relationship information while panning. The viewport can trigger an action event in response to panning across a panning boundary. The GUI can include a single network element data model for each network element to provide a view-specific network element vector graphic with context-sensitive detail for each of the views. A level navigator can switch between the first level view and the second level view in response to user activation, which can include: selection of the selected network element in the first level view; or zooming in on an area that includes the selected network element in the first level view. The zooming can trigger the level navigator in response to crossing a zoom boundary of two functional areas.

The GUI can further include a third level view lower in hierarchy than the second level view and showing properties in the network context of a card of the at least one network element. In that case, a level navigator can switch directly between the first level view and the third level view in response to user activation without displaying the second level view. The third level view can include a graphical port level alarm indication to display an alarm in a network context. The GUI can further include a network topology engine to automatically discover and generate a network topology without user input. An image export function can export a displayed image from the GUI at any level or view. The network can be a telecommunication network or an optical network.

In another aspect, the present invention provides a computer readable medium containing computer instructions which, when executed, cause a processor to provide a graphical user interface (GUI) for enabling management of network elements in a network, comprising: instructions for displaying, in a first level view, a plurality of network element groupings in a network context, showing relationships between the network element groupings; and instructions for displaying, in a second level view, a selected network element grouping from the first level view, the second level view showing lower level properties in the network context of at least one network element of the selected network element grouping. In a further aspect, the present invention provides a method of providing a graphical user interface for enabling management of network elements in a network, including steps as performed by the instructions when executed.

As mentioned earlier, embodiments of the present invention enable a user to conveniently navigate the management aspects of a network from a single application. The ability to provide different hierarchical and functional views, and navigation between the views, via a single application is facilitated by a single underlying set of data. This set of data also enables drawing the interconnecting topology. The underlying data model to enable this system in not known in previous element management systems that require a user to log in separately to different applications to obtain different views. In previous approaches, many separate element profiles are grouped together in a profile and a user must individually log into each one separately on demand if information is desired from it; alternatively, a user opens a session with each NE and draws data out of it, but does not obtain a lot of detail about each NE beyond what is immediately required. According to an embodiment of the present invention, only one NE needs to be logged into as a “host” shelf to launch the application, and other NEs are temporarily logged into in order to obtain additional information, without establishing a permanent connection. Alternatively, an embodiment of the present invention can include opening a session to every network element in the system, which enables the equivalent of an enterprise EMS.

According to an embodiment of the present invention, each network element has an associated data set. The network element data set includes sufficient data to provide context-sensitive information and images for each hierarchical and functional view. Therefore, each item in the GUI viewer represents more than just what is displayed at a particular view, and includes multi-layer details. In other words, each object is a multi-function object. At each level or view, the same object can present and interact differently, and data at the site level can have multiple functions. Therefore, not only can each object embody a plurality of functional areas of data, but the visual representation of the object itself can morph depending on how it is manipulated, such as which layer or view it is accessed from. For example, the same object can be represented in different views as a box, a schematic, or a plurality of light paths, and can include information about alarms, performance monitoring data, etc. There can also be different views of the same object in the same layer. For example, an object can be seen either as a gray box with buttons around it, or as multiple small cards connected to each other.

Each network element preferably has network-aware functionality, so that it shares information independent of any higher-level network management system. In other words, an embodiment of the present invention provides functionality typically associated with a network management system, but which is now being pulled down into the element management user interface, since the data is available at that level and can be relied upon. In fact, there is enough data stored in each network element data set to describe all of the network elements it connects to. Since this data collection and sharing is performed independent of any higher level network management system, embodiments of the present invention provide interoperability with various layouts and schemes while providing enhanced functionality.

A network element data set can be described as an object that can become laterally and vertically multi-functional by context-switched morphing. An example of a vertical multi-functionality is a context switch between network layers. For example, a single NE shelf object can be represented by an abstract iconic graphics at the site level where multiple shelves reside; however, when vertically zoomed in, it becomes a group of connected card schematics. An example of a lateral multi-functionality is a context switch between functional usages. Furthermore, an embodiment of the present invention allows for direct manipulation of the shelf object itself, for example a lateral context switch for the shelf to become a physical rack, or to show communications data, etc. This can be done by direct manipulation of the object's graphics. By doing this type of morphing, visual real estate can be saved by not always needing more widget panels to show other representations of the shelf.

The network element data set can be related to detailed schematics to be shown in a schematic view. These detailed schematics can be provided, for example, in a Visio stencil, which includes a plurality of Visio diagrams visually representing engineering data packages which describe elements of a network. The Visio schematics are preferably fully drawn and show elements fully connected, and are provided as a pre-configured template including connections. A user can insert relevant connection data, or this connection data can alternatively be automatically discovered.

With respect to the contents of the network element data set, this can include a hierarchical list of parameters on the basis of which that system diagram can be drawn. For example, the data for each NE can indicate that it is a member of an optical system having an OSID, that it is a linear topology, and the order in which it was listed would identify the connected order of the network elements. Other data that can be included in the network element data set include: product name; product type; element type (e.g. module type, amplifier type, OSC type, SCMD8 type, DSCM type); rack location; shelf number; slot number; channel group; channel group input wavelength; channel group output wavelength; product equipment code; part code; panel; port number(s); destination; connector type; or direction. The data set information is related to another embodiment of the present invention, which provides a method of discovering and listing all of the node elements in the system based on their relationship to each other.

In other words, in an aspect, the present invention provides a computer readable medium storing a network element data set, preferably for use with a graphical user interface (GUI) for network element management including: network element data including technical characteristics of a selected network element; relationship data representing logical and physical relationships between the selected network element and other network elements; and vector graphic data to provide a view-specific network element vector graphic with context-sensitive detail for each of a plurality of views.

An embodiment of the present invention automatically generates a network topology diagram by discovering the topology and embodying it in the way it is laid out. Using known systems, it is typically only possible to navigate through various layers (network, site, shelf) via unrelated applications that each display a particular layer, and do not interact with one another. Unless manually provided by a user, the unrelated applications typically do not include connection information necessary to build a network topology. Element management systems (EMS) exist at a network-management layer, but each NE appears in a manually user-formatted form.

Embodiments of the present invention provide more knowledge of the optical interconnection of NEs in the same OSID (OSID Group) and knowledge of multiple OSID groups which are interconnected in an arbitrary topology. This is because of the internal data model for each NE, as well as the discovery mechanism.

Some EMS and Network Management applications require manual user definition of network element topology and network element canvas layout or positioning. Embodiments of the present invention obviate the need for manual user input by providing for automatic discovery and generation of a network topology. In an embodiment, the GUI or another software entity has a process by which it retrieves information at local NE; if a user zooms in, the GUI has all information to zoom in, and in meantime it collects other information to be able to zoom out. Eventually, it collects enough information to be able to draw a network topology.

The present invention also provides more than one way to acquire or discover data from the network itself. Embodiments of the present invention provide a distributed discovery mechanism that is self-launched based on the location where you log in to the network. The GUI can enable a user to log in to any NE, obtain all of the information required to draw the topology of the network, then display whichever details are desired. In other words, the same topology can be generated from any one of the network elements. Most known approaches use a navigation tree, or nav tree, structure, like a file list in a desktop file explorer, which typically does not indicate the relationship between any files. While in the data world a ping trace can provide connection information, there is no analogy in the optical world.

A system or GUI according to an embodiment of the present invention is of particular benefit to those who work in the field and provide support for networks. Using previous generation optical products, it would take 1-3 days to log into the network, obtain data, analyze the network, and draw a picture of the network topology. Once all of the data had been obtained in the context of the network topology, it only typically took a couple of hours to solve the problem. Therefore, when applied to support management, embodiments of the present invention can provide substantial time and cost savings by automatically discovering and generating a network topology showing interconnectedness of network elements, including branched elements, and providing network information in the context of the network topology.

In other words, in a further aspect, the present invention provides a method of generating a network topology including: automatically discovering network topology information based on element and relationship data stored at each network element, without user input; and generating the network topology based on the automatically discovered network topology information.

In summary, an embodiment of the present invention provides a graphical user interface which allows a user to visually navigate multiple layers or multiple functional and/or physical areas of the network. In a further embodiment, there is provided a zoomable user interface for a network management system which allows the user to zoom from a network topology view right to a node or even a card schematic view (and potentially further). A further aspect provides a graphical user interface for a network management system which allows for contextual navigation of the network by allowing a user to easily switch views between the elements of the network, and the channels, connections and/or services carried by the network.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A graphical user interface (GUI) for managing network elements in a network, comprising:
a first level view to display a plurality of network element groupings in a network context, showing relationships between the network element groupings; and
a second level view to display a selected network element grouping from the first level view, the second level view showing lower level properties in the network context of at least one network element of the selected network element grouping.

2. The GUI of claim 1 wherein the first level view is a site level view and the network element groupings are site groupings comprising network elements co-located at the same physical site.

3. The GUI of claim 1 wherein the first level view is an optical system topology view and the network element groupings are optical system identification (OSID) groupings comprising network elements having the same OSID.

4. The GUI of claim 3 wherein the OSID groupings themselves include site groupings comprising network elements co-located at the same physical site.

5. The GUI of claim 1 further comprising an alternate functional view displaying functional properties associated with the displayed related network elements.

6. The GUI of claim 1 wherein a currently displayed view shows a portion of a total viewable image as seen through a viewport.

7. The GUI of claim 6 wherein the viewport can pan across the total viewable image in response to user direction, displaying relationship information while panning.

8. The GUI of claim 7 wherein the viewport triggers an action event in response to panning across a panning boundary.

9. The GUI of claim 1 comprising a single network element data model for each network element to provide a view-specific network element vector graphic with context-sensitive detail for each of the views.

10. The GUI of claim 1 further comprising a level navigator to switch between the first level view and the second level view in response to user activation.

11. The GUI of claim 10 wherein the user activation comprises selection of the selected network element in the first level view.

12. The GUI of claim 10 wherein the user activation comprises zooming in on an area that includes the selected network element in the first level view.

13. The GUI of claim 12 wherein the zooming triggers the level navigator in response to crossing a zoom boundary of two functional areas.

14. The GUI of claim 1 further comprising a third level view lower in hierarchy than the second level view and showing properties in the network context of a card of the at least one network element.

15. The GUI of claim 14 further comprising a level navigator to switch directly between the first level view and the third level view in response to user activation without displaying the second level view.

16. The GUI of claim 14 wherein the third level view comprises a graphical port level alarm indication to display an alarm in a network context.

17. The GUI of claim 1 further comprising a network topology engine to automatically discover and generate a network topology without user input.

18. The GUI of claim 1 further comprising an image export function to export a displayed image from the GUI at any level or view.

19. The GUI of claim 1 wherein the network is an optical network.

20. A computer readable medium containing computer instructions which, when executed, cause a processor to provide a graphical user interface (GUI) for enabling management of network elements in a network, comprising:
instructions for displaying, in a first level view, a plurality of network element groupings in a network context, showing relationships between the network element groupings; and
instructions for displaying, in a second level view, a selected network element grouping from the first level view, the second level view showing lower level properties in the network context of at least one network element of the selected network element grouping.
